(19) United States
(12) Patent Application Publication
(10) Pub. No.: US 2015/0268820 A1
(43) Pub. Date: Sep. 24, 2015

(54) CAUSATION OF A RENDERING APPARATUS TO RENDER A RENDERING MEDIA ITEM

(71) Applicant: Nokia Corporation, Espoo (FI)

(72) Inventors: Jussi Artturi LEPPANEN, Tampere (FI); Arto Juhani LEHTINIEMI, Lempaala (FI); Antti Johannes ERONEN, Tampere (FI)

(21) Appl. No.: 14/218,848

(22) Filed: Mar. 18, 2014

(51) Int. Cl. G06F 3/0484

(52) U.S. Cl. CPC G06F 3/04842

(57) ABSTRACT

A method comprising determining that an apparatus is pointing at a separate apparatus, receiving information indicative of at least one media item candidate from the separate apparatus based, at least in part, on the determination that the apparatus is pointing at the separate apparatus, determining a rendering media item based, at least in part, on the media item candidate, determining that the apparatus is pointing at a rendering apparatus, and causing the rendering apparatus to render the rendering media item based, at least in part, on the determination that the apparatus is pointing at the rendering apparatus is disclosed.

### TECHNICAL FIELD

The present application relates generally to rendering of a rendering media item.

### BACKGROUND

As electronic apparatus have become increasingly prevalent and increasingly pervasive in our society, many user have grown accustom to utilizing multiple electronic apparatuses in conjunctions with each other, in unison, and/or the like. For example, a user may utilize an electronic apparatus to listen to music, and another electronic apparatus to stream movies. In many circumstances, it may be desirable to allow a user to interact with the user's electronic apparatuses in a manner that is easy and intuitive, and allows the user to synergistically utilize the user's electronic apparatuses.

### SUMMARY

Various aspects of examples of the invention are set out in the claims.

One or more embodiments may provide an apparatus, a computer readable medium, a non-transitory computer readable medium, a computer program product, and/or a method for determining that the apparatus is pointing at a separate apparatus, receiving information indicative of at least one media item candidate from the separate apparatus based, at least in part, on the determination that the apparatus is pointing at the separate apparatus, determining a rendering media item based, at least in part, on the media item candidate, determining that the apparatus is pointing at a rendering apparatus, and causing the rendering apparatus to render the rendering media item based, at least in part, on the determination that the apparatus is pointing at the rendering apparatus.

One or more embodiments may provide an apparatus, a computer readable medium, a computer program product, and/or a non-transitory computer readable medium having means for determining that an apparatus is pointing at a separate apparatus, means for receiving information indicative of at least one media item candidate from the separate apparatus based, at least in part, on the determination that the apparatus is pointing at the separate apparatus, means for determining a rendering media item based, at least in part, on the media item candidate, means for determining that the apparatus is pointing at a rendering apparatus, and means for causing the rendering apparatus to render the rendering media item based, at least in part, on the determination that the apparatus is pointing at the rendering apparatus.

One or more example embodiments further perform determination that the separate apparatus is proximate to the apparatus, wherein the determination that the apparatus is pointing at the separate apparatus is based, at least in part, on the determination that the separate apparatus is proximate to the apparatus.

In at least one example embodiment, the determination that the apparatus is pointing at the separate apparatus comprises determination that a predetermined portion of the apparatus is facing the separate apparatus.

In at least one example embodiment, the predetermined portion of the apparatus is a top of the apparatus.

In at least one example embodiment, the separate apparatus is the rendering apparatus.

In at least one example embodiment, the rendering apparatus is an apparatus to which at least one media item is sent such that the media item is rendered by the rendering apparatus.

In at least one example embodiment, the causation of the rendering apparatus to render the rendering media item comprises sending of the rendering media item to the rendering apparatus such that the rendering apparatus renders the rendering media item.

One or more example embodiments further perform causation of display of a media item candidate interface element that represents the media item candidate based, at least in part, on the determination that the apparatus is pointing at the separate apparatus.

In at least one example embodiment, the determination of the rendering media item is based, at least in part, on a selection input that identifies the media item candidate as the rendering media item.

One or more example embodiments further perform receipt of information indicative of the selection input.

In at least one example embodiment, the causation of display of the media item candidate interface element that represents the media item candidate comprises causation of display of the media item candidate interface element at a display position on a display, and the selection input is at an input position that corresponds with the display position.

In at least one example embodiment, the selection input comprises an initiation portion of the selection input and a termination portion of the selection input such that the apparatus receives the initiation portion of the selection input subsequent to the determination that the apparatus is pointing at the separate apparatus and prior to the determination that the apparatus is pointing at the rendering apparatus.

In at least one example embodiment, the apparatus receives the termination portion of the selection input subsequent to the determination that the apparatus is pointing at the rendering apparatus.

In at least one example embodiment, the causation of the rendering apparatus to render the rendering media item is based, at least in part, on the termination portion of the selection input.

In at least one example embodiment, the apparatus receives the termination portion of the selection input prior to the determination that the apparatus is pointing at the rendering apparatus.

One or more example embodiments further perform causation of display of at least another media item candidate interface element that represents at least another media item candidate, the other media item candidate being associated with a media item playlist, and such that the other media item candidate interface element is displayed in relation to the media item candidate interface element.

In at least one example embodiment, the selection input comprises an initiation portion of the selection input and a termination portion of the selection input, the initiation portion of the selection input is at a position that corresponds with the media item candidate interface element, and the termination portion of the selection input is at a position that corresponds with the other media item candidate interface element.

One or more example embodiments further perform establishment of an association between the media item candidate and the media item playlist based, at least in part, on the termination portion of the selection input.

In at least one example embodiment, the determination of the rendering media item is based, at least in part, on the association between the media item candidate and the media item playlist.

In at least one example embodiment, the causation of the rendering apparatus to render the rendering media item is based, at least in part, on the association between the media item candidate and the media item playlist.

In at least one example embodiment, the causation of the rendering apparatus to render the rendering media item comprises causation of the rendering apparatus to render the media item playlist.

In at least one example embodiment, the rendering of the media item playlist comprises rendering of the rendering media item.

One or more example embodiments further perform establishment of an association between the media item candidate and the media item playlist based, at least in part, on the termination portion of the selection input being at a position that corresponds with the other media item candidate interface element.

In at least one example embodiment, the selection input is received subsequent to the determination that the apparatus is pointing at the rendering apparatus.

One or more example embodiments further perform determination of at least one media item selection criteria.

In at least one example embodiment, the media item selection criteria relates to designation of a constraint on selection of a media item candidate based, at least in part, on metadata associated with the media item candidate.

In at least one example embodiment, the determination of the rendering media item is based, at least in part, on the media item selection criteria.

One or more example embodiments further perform sending of information indicative of the media item selection criteria to the separate apparatus, wherein the media item candidate satisfies the media item selection criteria.

In at least one example embodiment, the sending of information indicative of the media item selection criteria to the separate apparatus causes the separate apparatus to constrain the media item candidate to a media item candidate that satisfies the media item selection criteria.

One or more example embodiments further perform determination of at least one host media item candidate, the host media item candidate being a media item that is associated with the apparatus.

In at least one example embodiment, the determination of the rendering media item is further based, at least in part, on the host media candidate.

One or more example embodiments further perform causation of rendering of the host media item candidate.

One or more example embodiments further perform causation of display of a media item candidate interface element that represents the host media item candidate based, at least in part, on the determination that the apparatus is pointing at the separate apparatus.

One or more example embodiments further perform causation of display of a media item candidate interface element that represents the host media item candidate based, at least in part, on the determination that the apparatus is pointing at the rendering apparatus.

In at least one example embodiment, the determination of the rendering media item is based, at least in part, on a selection input that identifies the host media item candidate as the rendering media item.

One or more example embodiments further perform receipt of information indicative of the selection input.

In at least one example embodiment, the causation of display of the media item candidate interface element that represents the host media item candidate comprises causation of display of the media item candidate interface element at a display position on a display, and the selection input is at an input position that corresponds with the display position.

### BRIEF DESCRIPTION OF THE DRAWINGS

For a more complete understanding of embodiments of the invention, reference is now made to the following descriptions taken in connection with the accompanying drawings in which:

FIG. 1 is a block diagram showing an apparatus according to at least one example embodiment;

FIGS. 2A-2B are block diagrams showing apparatus communication according to at least one example embodiment;

FIGS. 3A-3C are diagrams illustrating an apparatus pointing at another apparatus according to at least one example embodiment;

FIGS. 4A-4E are diagrams illustrating a media item candidate interface element according to at least one example embodiment;

FIG. 5 is a flow diagram illustrating activities associated with causation of a rendering apparatus to render a rendering media item according to at least one example embodiment;

FIG. 6 is a flow diagram illustrating activities associated with causation of a rendering apparatus to render a rendering media item according to at least one example embodiment;

FIG. 7 is a flow diagram illustrating activities associated with causation of a rendering apparatus to render a rendering media item according to at least one example embodiment;

FIG. 8 is a flow diagram illustrating activities associated with causation of a rendering apparatus to render a rendering media item according to at least one example embodiment; and

FIG. 9 is a flow diagram illustrating activities associated with causation of a rendering apparatus to render a media item playlist according to at least one example embodiment.

### DETAILED DESCRIPTION OF THE DRAWINGS

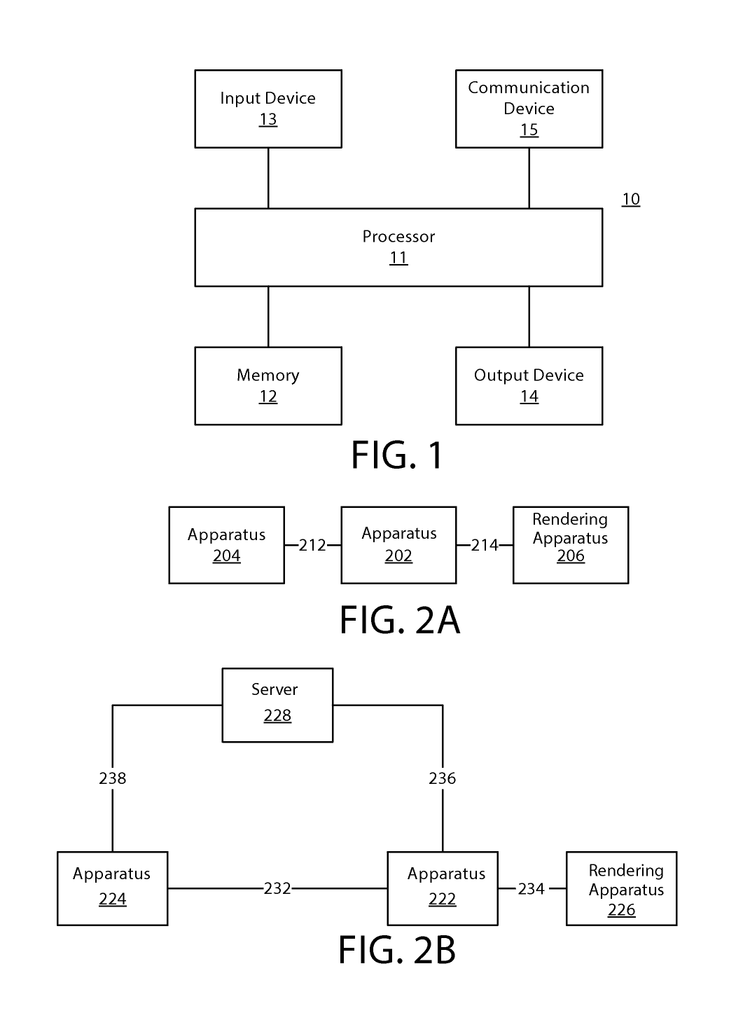

An embodiment of the invention and its potential advantages are understood by referring to FIGS. 1 through 9 of the drawings.

Some embodiments will now be described more fully hereinafter with reference to the accompanying drawings, in which some, but not all, embodiments are shown. Various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network apparatus, other network apparatus, and/or other computing apparatus.

As defined herein, a “non-transitory computer-readable medium,” which refers to a physical medium (e.g., volatile or non-volatile memory device), can be differentiated from a “transitory computer-readable medium,” which refers to an electromagnetic signal.

FIG. 1 is a block diagram showing an apparatus, such as an electronic apparatus 10, according to at least one example embodiment. It should be understood, however, that an electronic apparatus as illustrated and hereinafter described is merely illustrative of an electronic apparatus that could benefit from embodiments of the invention and, therefore, should not be taken to limit the scope of the invention. While electronic apparatus 10 is illustrated and will be hereinafter described for purposes of example, other types of electronic apparatuses may readily employ embodiments of the invention. Electronic apparatus 10 may be a personal digital assistant (PDAs), a pager, a mobile computer, a desktop computer, a television, a gaming apparatus, a laptop computer, a tablet computer, a media player, a camera, a video recorder, a mobile phone, a global positioning system (GPS) apparatus, a rendering apparatus, a server, an automobile, a kiosk, an electronic table, and/or any other types of electronic systems. Moreover, the apparatus of at least one example embodiment need not be the entire electronic apparatus, but may be a component or group of components of the electronic apparatus in other example embodiments. For example, the apparatus may be an integrated circuit, a set of integrated circuits, and/or the like.

Furthermore, apparatuses may readily employ embodiments of the invention regardless of their intent to provide mobility. In this regard, even though embodiments of the invention may be described in conjunction with mobile applications, it should be understood that embodiments of the invention may be utilized in conjunction with a variety of other applications, both in the mobile communications industries and outside of the mobile communications industries. For example, the apparatus may be, at least part of, a non-carryable apparatus, such as a large screen television, an electronic table, a kiosk, an automobile, and/or the like.

In at least one example embodiment, electronic apparatus 10 comprises processor 11 and memory 12. Processor 11 may be any type of processor, controller, embedded controller, processor core, and/or the like. In at least one example embodiment, processor 11 utilizes computer program code to cause an apparatus to perform one or more actions. Memory 12 may comprise volatile memory, such as volatile Random Access Memory (RAM) including a cache area for the temporary storage of data and/or other memory, for example, non-volatile memory, which may be embedded and/or may be removable. The non-volatile memory may comprise an EEPROM, flash memory and/or the like. Memory 12 may store any of a number of pieces of information, and data. The information and data may be used by the electronic apparatus 10 to implement one or more functions of the electronic apparatus 10, such as the functions described herein. In at least one example embodiment, memory 12 includes computer program code such that the memory and the computer program code are configured to, working with the processor, cause the apparatus to perform one or more actions described herein.

The electronic apparatus 10 may further comprise a communication device 15. In at least one example embodiment, communication device 15 comprises an antenna, (or multiple antennae), a wired connector, and/or the like in operable communication with a transmitter and/or a receiver. In at least one example embodiment, processor 11 provides signals to a transmitter and/or receives signals from a receiver. The signals may comprise signaling information in accordance with a communications interface standard, user speech, received data, user generated data, and/or the like. Communication device 15 may operate with one or more air interface standards, communication protocols, modulation types, and access types. By way of illustration, the electronic communication device 15 may operate in accordance with second-generation (2G) wireless communication protocols IS-136 (time division multiple access (TDMA)), Global System for Mobile communications (GSM), and IS-95 (code division multiple access (CDMA)), with third-generation (3G) wireless communication protocols, such as Universal Mobile Telecommunications System (UMTS), CDMA2000, wideband CDMA (WCDMA) and time division-synchronous CDMA (TD-SCDMA), and/or with fourth-generation (4G) wireless communication protocols, wireless networking protocols, such as 802.11, short-range wireless protocols, such as Bluetooth, and/or the like. Communication device 15 may operate in accordance with wireline protocols, such as Ethernet, digital subscriber line (DSL), asynchronous transfer mode (ATM), and/or the like.

Processor 11 may comprise means, such as circuitry, for implementing audio, video, communication, navigation, logic functions, and/or the like, as well as for implementing embodiments of the invention including, for example, one or more of the functions described herein. For example, processor 11 may comprise means, such as a digital signal processor device, a microprocessor device, various analog to digital converters, digital to analog converters, processing circuitry and other support circuits, for performing various functions including, for example, one or more of the functions described herein. The apparatus may perform control and signal processing functions of the electronic apparatus 10 among these devices according to their respective capabilities. The processor 11 thus may comprise the functionality to encode and interleave message and data prior to modulation and transmission. The processor 1 may additionally comprise an internal voice coder, and may comprise an internal data modem. Further, the processor 11 may comprise functionality to operate one or more software programs, which may be stored in memory and which may, among other things, cause the processor 11 to implement at least one embodiment including, for example, one or more of the functions described herein. For example, the processor 11 may operate a connectivity program, such as a conventional internet browser. The connectivity program may allow the electronic apparatus 10 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

The electronic apparatus 10 may comprise a user interface for providing output and/or receiving input. The electronic apparatus 10 may comprise an output device 14. Output device 14 may comprise an audio output device, such as a ringer, an earphone, a speaker, and/or the like. Output device 14 may comprise a tactile output device, such as a vibration transducer, an electronically deformable surface, an electronically deformable structure, and/or the like. Output device 14 may comprise a visual output device, such as a display, a light, and/or the like. In at least one example embodiment, the apparatus causes display of information, the causation of display may comprise displaying the information on a display comprised by the apparatus, sending the information to a separate apparatus that comprises a display, and/or the like. The electronic apparatus may comprise an input device 13. Input device 13 may comprise a light sensor, a proximity sensor, a microphone, a touch sensor, a force sensor, a button, a keypad, a motion sensor, a magnetic field sensor, a camera, and/or the like. A touch sensor and a display may be characterized as a touch display. In an embodiment comprising a touch display, the touch display may be configured to receive input from a single point of contact, multiple points of contact, and/or the like. In such an embodiment, the touch display and/or the processor may determine input based, at least in part, on position, motion, speed, contact area, and/or the like. In at least one example embodiment, the apparatus receives an indication of an input. The apparatus may receive the indication from a sensor, a driver, a separate apparatus, and/or the like. The information indicative of the input may comprise information that conveys information indicative of the input, indicative of an aspect of the input indicative of occurrence of the input, and/or the like.

The electronic apparatus 10 may include any of a variety of touch displays including those that are configured to enable touch recognition by any of resistive, capacitive, infrared, strain gauge, surface wave, optical imaging, dispersive signal technology, acoustic pulse recognition or other techniques, and to then provide signals indicative of the location and other parameters associated with the touch. Additionally, the touch display may be configured to receive an indication of an input in the form of a touch event which may be defined as an actual physical contact between a selection object (e.g., a finger, stylus, pen, pencil, or other pointing device) and the touch display. Alternatively, a touch event may be defined as bringing the selection object in proximity to the touch display, hovering over a displayed object or approaching an object within a predefined distance, even though physical contact is not made with the touch display. As such, a touch input may comprise any input that is detected by a touch display including touch events that involve actual physical contact and touch events that do not involve physical contact but that are otherwise detected by the touch display, such as a result of the proximity of the selection object to the touch display. A touch display may be capable of receiving information associated with force applied to the touch screen in relation to the touch input. For example, the touch screen may differentiate between a heavy press touch input and a light press touch input. In at least one example embodiment, a display may display two-dimensional information, three-dimensional information and/or the like.

In embodiments including a keypad, the keypad may comprise numeric (for example, 0-9) keys, symbol keys (for example, #, *), alphabetic keys, and/or the like for operating the electronic apparatus 10. For example, the keypad may comprise a conventional QWERTY keypad arrangement. The keypad may also comprise various soft keys with associated functions. In addition, or alternatively, the electronic apparatus 10 may comprise an interface device such as a joystick or other user input interface.

Input device 13 may comprise a media capturing element. The media capturing element may be any means for capturing an image, video, and/or audio for storage, display or transmission. For example, in at least one example embodiment in which the media capturing element is a camera module, the camera module may comprise a digital camera which may form a digital image file from a captured image. As such, the camera module may comprise hardware, such as a lens or other optical component(s), and/or software necessary for creating a digital image file from a captured image. Alternatively, the camera module may comprise only the hardware for viewing an image, while a memory device of the electronic apparatus 10 stores instructions for execution by the processor 11 in the form of software for creating a digital image file from a captured image. In at least one example embodiment, the camera module may further comprise a processing element such as a co-processor that assists the processor 11 in processing image data and an encoder and/or decoder for compressing and/or decompressing image data. The encoder and/or decoder may encode and/or decode according to a standard format, for example, a Joint Photographic Experts Group (JPEG) standard format.

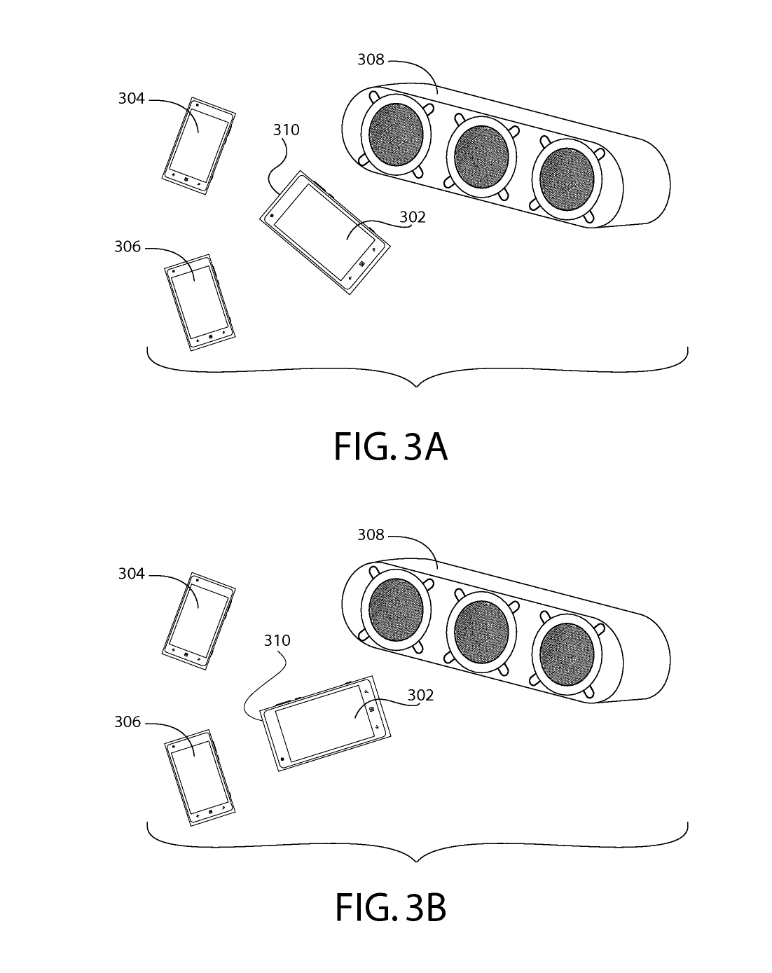

FIGS. 2A-2B are diagrams illustrating apparatus communication according to at least one example embodiment. The examples of FIGS. 2A-2B are merely examples and do not limit the scope of the claims. For example, communication paths may vary, apparatus count may vary, server count may vary, apparatus, server, and/or rendering apparatus designations may vary, apparatus, server, and/or rendering apparatus configuration may vary, and/or the like.

FIG. 2A is a diagram illustrating apparatus communication according to at least one example embodiment. The example of FIG. 2A depicts apparatus 202 in communication with apparatus 204 by way of communication channel 212, and apparatus 202 in communication with rendering apparatus 206 by way of communication channel 214. In the example of FIG. 2A, apparatus 204 may indirectly communicate with rendering apparatus 206 via apparatus 202 by way of communication channels 212 and 214, and rendering apparatus 206 may indirectly communicate with apparatus 204 via apparatus 202 by way of communication channels 214 and 212. For example, apparatus 204 may cause sending of information to apparatus 202 by way of communication channel 212, and apparatus 202 may forward the information from apparatus 204 to rendering apparatus 206 by way of communication channel 214. Similarly, apparatus 204 may receive information from rendering apparatus 206 by way of apparatus 202. In such an example, apparatus 202 may receive information from rendering apparatus 206, and may forward the information from rendering apparatus 206 to apparatus 204.

It should be understood that, even though FIG. 2A illustrates a direct communication channel between apparatus 204 and apparatus 202, and between apparatus 202 and rendering apparatus 206, there may be intermediate apparatuses that facilitate communication between apparatus 204 and apparatus 202, and/or between apparatus 202 and rendering apparatus 206. For example, there may be one or more routers, hubs, switches, gateways, and/or the like, that are utilized in the communication channels between apparatus 204 and apparatus 202, and/or between apparatus 202 and rendering apparatus 206. In addition, there may be other separate apparatuses that apparatus 204, apparatus 202, and/or rendering apparatus 206 are in communication with. For example, apparatus 204, apparatus 202, and/or rendering apparatus 206 may be in communication with another apparatus, another rendering apparatus, a different separate apparatus, and/or the like.

In some circumstances, a user may desire to have collaboration between apparatuses, such as between an apparatus and a separate apparatus, based on their proximity with each other. For example, it may be intuitive for a user to manage collaboration between apparatuses that are local to each other. A plurality of apparatuses may be proximate to each other based on location, availability of local communication among the apparatuses, and/or the like. For example, if the apparatuses collaborate by way of low power radio frequency communication, a radio frequency communication, near field communication, inductive communication, electric field communication, Bluetooth communication, infrared communication, local area network communication, wireless local area network communication, and/or the like, the apparatuses may be considered to be proximate with each other based, at least in part, on availability of such proximity-based communication with each other. In at least one example embodiment, apparatuses include electronic apparatuses, peripheral apparatuses, host apparatus, and/or the like. In at least one example embodiment, apparatuses communicate with each other. For example, an apparatus may be an apparatus that automatically communicates with another apparatus for purposes such as identifying the apparatus, synchronizing data, exchanging status information, and/or the like. In at least one example embodiment, an apparatus retains information associated with communication with a separate apparatus. For example the apparatus may comprise information associated with identifying, communicating with, authenticating, performing authentication with, and/or the like, the separate apparatus. In this manner, the apparatus may be privileged to perform operations in conjunction with the separate apparatus that a different apparatus may lack the privilege to perform.

In at least one example embodiment, communication based, at least in part, on short range communication is referred to as proximity-based communication. In at least one example embodiment, proximity-based communication relates to wireless communication that is associated with a short range, such as low power radio frequency communication, radio frequency communication, near field communication, inductive communication, electric field communication, Bluetooth communication, infrared communication, local area network communication, wireless local area network communication, and/or the like. In such an example, the exchange of information may be by way of the short range wireless communication between the apparatus and a separate apparatus, host apparatus, and/or the like.

In at least one example embodiment, a proximity-based communication channel is a low power radio frequency communication channel, a radio frequency communication channel, a near field communication channel, a wireless communication channel, a wireless local area network communication channel, a Bluetooth communication channel, an electric field communication channel, an inductive communication channel, an infrared communication channel, and/or the like. For example, as depicted in FIG. 2A, apparatus 202 communicates with apparatus 204 by way of a communication channel 212. In the example of FIG. 2A, communication channel 212 may be a low power radio frequency communication channel, a radio frequency communication channel, a near field communication channel, a wireless communication channel, a wireless local area network communication channel, a Bluetooth communication channel, an electric field communication channel, an inductive communication channel, an infrared communication channel, and/or the like. Similarly, as depicted in FIG. 2A, apparatus 202 communicates with rendering apparatus 206 by way of communication channel 214. In the example of FIG. 2A, communication channel 214 may be a low power radio frequency communication channel, a radio frequency communication channel, a near field communication channel, a wireless communication channel, a wireless local area network communication channel, a Bluetooth communication channel, an electric field communication channel, an inductive communication channel, an infrared communication channel, and/or the like.

FIG. 2B is a diagram illustrating apparatus communication according to at least one example embodiment. The example of FIG. 2B depicts apparatus 222 in communication with apparatus 224 by way of communication channel 232, and apparatus 222 in communication with rendering apparatus 226 by way of communication channel 234. The example of FIG. 2B also depicts server 228 in communication with apparatus 222 by way of communication channel 236 and with apparatus 224 by way of communication channel 238. In the example of FIG. 2B, apparatus 224 may indirectly communicate with rendering apparatus 226 via apparatus 222 by way of communication channels 232 and 234, and rendering apparatus 226 may indirectly communicate with apparatus 224 via apparatus 222 by way of communication channels 234 and 232. For example, apparatus 224 may cause sending of information to apparatus 222 by way of communication channel 232, and apparatus 222 may forward the information from apparatus 224 to rendering apparatus 226 by way of communication channel 234. Similarly, apparatus 224 may receive information from rendering apparatus 226 by way of apparatus 222. In such an example, apparatus 222 may receive information from rendering apparatus 226, and may forward the information from rendering apparatus 226 to apparatus 224. Additionally, apparatus 222 and/or apparatus 224 may receive information from server 228 by way of communication channels 236 and/or 238, respectively. In such an example, apparatus 222 and/or apparatus 224 may forward the information received from server 228 to each other, to rendering apparatus 226, and/or the like.

It should be understood that, even though FIG. 2B illustrates a direct communication channel between apparatus 224 and apparatus 222, between apparatus 222 and rendering apparatus 226, between server 228 and apparatus 222, and between server 228 and apparatus 224, there may be intermediate apparatuses that facilitate communication between apparatus 224 and apparatus 222, between apparatus 222 and rendering apparatus 226, between server 228 and apparatus 222, and/or between server 228 and apparatus 224. For example, there may be one or more routers, hubs, switches, gateways, and/or the like, that are utilized in the communication channels between apparatus 224 and apparatus 222, between apparatus 222 and rendering apparatus 226, between server 228 and apparatus 222, and/or between server 228 and apparatus 224. In addition, there may be other separate apparatuses that apparatus 224, apparatus 222, rendering apparatus 226, and/or server 228 are in communication with. For example, apparatus 224, apparatus 222, rendering apparatus 226, and/or server 228 may be in communication with another apparatus, another rendering apparatus, a different separate apparatus, another server, a different server, and/or the like.

In at least one example embodiment, an apparatus and a separate apparatus communicate by way of non-proximity-based communication channels. For example, as depicted in FIG. 2B, apparatus 222 communicates with server 228 by way of a communication channel 236. In the example of FIG. 2B, communication channel 236 may be a local area network communication channel, a wide area network communication channel, an internet communication channel, a cellular communication channel, and/or the like. Similarly, as depicted in FIG. 2B, apparatus 224 communicates with server 228 by way of communication channel 238. In the example of FIG. 2B, communication channel 238 may be a local area network communication channel, a wide area network communication channel, an internet communication channel, a cellular communication channel, and/or the like.

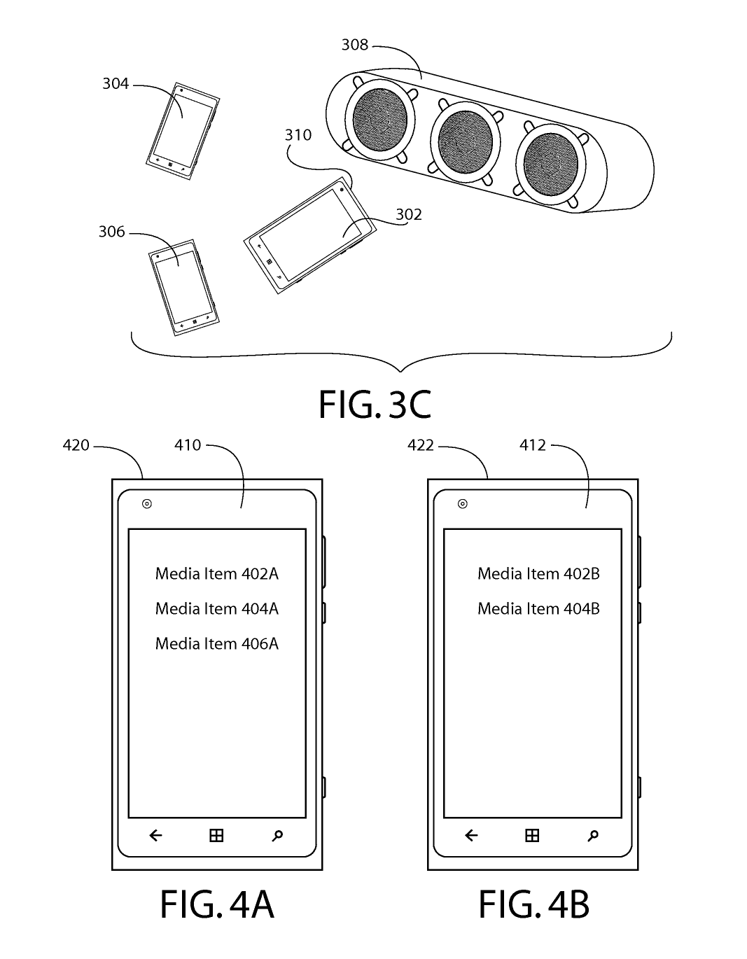

FIGS. 3A-3C are diagrams illustrating an apparatus pointing at another apparatus according to at least one example embodiment. The examples of FIGS. 3A-3C are merely examples and do not limit the scope of the claims. For example, apparatus count may vary, apparatus configuration may vary, apparatus orientation may vary, and/or the like.

Over the years, electronic apparatuses have become increasingly prevalent and increasing pervasive in our society. Users of such electronic apparatuses are utilizing their respective electronic apparatuses with respect to many aspects of their lives. For example, a user of an electronic apparatus may utilize the apparatus to communicate with friends, email with business contacts, manage a schedule, view weather information, and/or the like. Additionally, many users utilize their electronic apparatuses for purposes relating to entertainment and leisure. For example, a user may listen to music, watch a video, etc. by way of the user's electronic apparatus. In more recent times, many users utilize a plurality of electronic apparatuses in conjunction with one another. For example, a user may have more than one electronic apparatus that may be associated with streaming music services, may have music and/or video stored in memory, and/or the like. As such, it may be desirable to provide for an easy and intuitive manner in which a user of an electronic apparatus may be able to access music stored on a separate electronic apparatus, videos streamed by another electronic apparatus, and/or the like, by way of the user's electronic apparatus.

Many users may be familiar with certain actions and/or gestures that may be used to identify a particular item, a specific object, and/or the like. For example, many users may be familiar with pointing to an object to represent selection of the object, identification of the object, etc. As such, it may be desirable to configure an electronic apparatus such that a user of the electronic apparatus may indicate a desire to interact with another object by way of pointing at that other object. In at least one example embodiment, an apparatus determines that the apparatus is pointing at a separate apparatus. The separate apparatus may be a phone, a tablet, a computer, a storage apparatus, a television, a music player, a video player, and/or the like. In this manner, a user of the apparatus may identify a specific separate apparatus that the user may desire to interact with, access music from, and/or the like, by way of pointing the apparatus at the separate apparatus.

There are many manners in which an apparatus may determine that the apparatus is pointing at a separate apparatus, and there will likely be many additional manners in the future. As such, the manner in which the apparatus determines that the apparatus is pointing at the separate apparatus does not necessarily limit the scope of the claims. For example, the determination that the apparatus is pointing at the separate apparatus may comprise determination that a predetermined portion of the apparatus is facing the separate apparatus. The predetermined portion may be a top of the apparatus, a back of the apparatus, and/or the like. The apparatus may determine that the apparatus is pointing at the separate apparatus by way of one or more sensors, such as a camera module, an orientation sensor, a proximity sensor, a near field communication sensor, an infrared sensor, a radar sensor, and/or the like. In some circumstances, the apparatus may be a head mounted apparatus, a head mounted display, an audio headset, and/or the like. In such circumstances, pointing the apparatus at the separate apparatus may be associated with the user pointing his head, gaze, and/or the like, towards the separate apparatus.

In some circumstances, it may be desirable to limit identification of a separate apparatus by way of pointing an apparatus at the separate apparatus to circumstances where the separate apparatus is proximate to the apparatus. For example, it may be desirable to limit identification of separate apparatuses to those apparatuses which may be within an operable range of one or more proximity-based communication channels. In at least one example embodiment, an apparatus determines that the separate apparatus is proximate to the apparatus. In such an example embodiment, the determination that the apparatus is pointing at the separate apparatus may be based, at least in part, on the determination that the separate apparatus is proximate to the apparatus. For example, the apparatus may determine that the separate apparatus is proximate to the apparatus if the separate apparatus is within a threshold distance from the apparatus, is in communication with the apparatus by way of a proximity-based communication channel, and/or the like.

FIG. 3A is a diagram illustrating an apparatus pointing at a separate apparatus according to at least one example embodiment. In the example of FIG. 3A, apparatus 302 is proximate to separate apparatus 304, separate apparatus 306, and rendering apparatus 308. In the example of FIG. 3A, a user of apparatus 302 may desire to interact with apparatus 304. As such, the user may desire indicate such a desire to apparatus 302 by way of pointing top 310 of apparatus 302 towards separate apparatus 304. As depicted in FIG. 3A, the top 310 of apparatus 302 is pointing towards separate apparatus 304. As such, in the example of FIG. 3A, apparatus 302 may determine that apparatus 302 is pointing at separate apparatus 304 based, at least in part, on the determination that top 310 of apparatus 302 is pointing towards separate apparatus 304. As can be seen, top 310 fails to point towards separate apparatus 306 and rendering apparatus 308.

FIG. 3B is a diagram illustrating an apparatus pointing at a separate apparatus according to at least one example embodiment. The example of FIG. 3B depicts the scenario of FIG. 3A subsequent to reorienting apparatus 302 such that top 310 of apparatus 302 is pointing toward separate apparatus 306. As depicted in FIG. 3B, the top 310 of apparatus 302 is pointing towards separate apparatus 306. As such, in the example of FIG. 3B, apparatus 302 may determine that apparatus 302 is pointing at separate apparatus 306 based, at least in part, on the determination that top 310 of apparatus 302 is pointing towards separate apparatus 306. As can be seen, top 310 fails to point towards separate apparatus 304 and rendering apparatus 308. As such, apparatus 302 may be precluded from interacting with separate apparatus 304 and/or rendering apparatus 308 based, at least in part, on apparatus 302 pointing at separate apparatus 306, apparatus 302 failing to point at separate apparatus 304, apparatus 302 failing to point at rendering apparatus 308, and/or the like.

In many circumstances, an electronic apparatus may comprise a speaker, a display, and/or the like, that may be utilized to play music, to display a video, and/or the like. In such circumstances, a user may desire to render one or more media items, such as a song and/or a video, by way of the electronic apparatus. Due to the portable nature of many electronic apparatuses, often times, the display may be limited in size, the speaker may be limited in dynamic range and/or sound clarity, and/or the like. As such, many users may desire to play music, view a video, etc. by way of a separate apparatus, such as a rendering apparatus.

In at least one example embodiment, the separate apparatus is the rendering apparatus. A rendering apparatus may be an apparatus to which at least one media item is sent such that the media item is rendered by the rendering apparatus. For example, a rendering apparatus may be an apparatus that is particularly suited for rendering of a media item, specifically configured for rendering of media items, and/or the like. In this manner, rendering of a media item by way of the rendering apparatus may be characterized by a heightened level of rendering fidelity in comparison to rendering of the media item by way of the apparatus. For example, a rendering apparatus may be a Bluetooth speaker, a home audio system, a television, and/or the like. In this manner, the rendering apparatus may comprise a more robust speaker, a larger display, and/or the like, that may be utilized to render a media item.

In such circumstances, it may be desirable to configure an electronic apparatus such that a user of the electronic apparatus may interact with the apparatus, play music by way of the electronic apparatus, watch a video that may be streamed by the electronic apparatus, and/or the like, in an easy and intuitive manner. In order to facilitate utilization of a plurality of electronic apparatuses in conjunction with one another, it may be desirable to configure an electronic apparatus such that a user of the electronic apparatus may easily and intuitively access one or more media items that may be stored by a separate apparatus, may cause rendering of one or more media items by way of a rendering apparatus, and/or the like. In at least one example embodiment, an apparatus receives information indicative of at least one media item candidate from a separate apparatus based, at least in part, on the determination that the apparatus is pointing at the separate apparatus. A media item candidate may, for example, be a song, a video, an image, and/or the like, that may be caused to be rendered, selected to be rendered, and/or the like. Receipt of information indicative of a media item may, for example, relate to receipt of the media item, receipt of a reference associated with the media item, and/or the like

As discussed previously, in many circumstances, it may be desirable to render one or more media items, media item candidates, and/or the like. For example, in order to enhance a user's listening and/or viewing experience, it may be desirable to cause a rendering apparatus to render a specific media item, a particular media item candidate, and/or the like. As such, it may be desirable to indicate a specific media item that the user desires to have rendered, to determine to render a particular media item candidate, and/or the like. In at least one example embodiment, an apparatus determines a rendering media item based, at least in part, on the media item candidate. The rendering media item may be a media item candidate that is to be rendered by a rendering apparatus, by another apparatus, and/or the like. In such circumstances, it may be desirable to configure an apparatus such that the apparatus may interact with a rendering apparatus based, at least in part, on the apparatus being pointed at the rendering apparatus, similar as described regarding the apparatus being pointed at a separate apparatus. For example, the apparatus may determine that the apparatus is pointed at a separate apparatus, may receive information indicative of one or more media item candidates from the separate apparatus, and determine a rendering media item based, at least in part, on the media item candidate. In such an example, the user of the apparatus may desire to cause a particular rendering apparatus to render the rendering media item in a manner that is easy and intuitive. In at least one example embodiment, an apparatus determines that the apparatus is pointing at a rendering apparatus. In such an example embodiment, the apparatus may cause the rendering apparatus to render the rendering media item based, at least in part, on the determination that the apparatus is pointing at the rendering apparatus. Causation of the rendering apparatus to render the rendering media item may comprise sending of the rendering media item to the rendering apparatus such that the rendering apparatus renders the rendering media item, sending of an indication of the rendering media item to the rendering apparatus such that the rendering apparatus retrieves the rendering media item from another apparatus and, subsequently, renders the rendering media item, and/or the like.

FIG. 3C is a diagram illustrating an apparatus pointing at a rendering apparatus according to at least one example embodiment. The example of FIG. 3C depicts the scenario of FIG. 3A and/or FIG. 3B subsequent to reorienting apparatus 302 such that top 310 of apparatus 302 is pointing toward rendering apparatus 308. As depicted in FIG. 3C, the top 310 of apparatus 302 is pointing towards rendering apparatus 308. As such, in the example of FIG. 3C, apparatus 302 may cause rendering apparatus 308 to render a rendering media item based, at least in part, on the determination that top 310 of apparatus 302 is pointing towards rendering apparatus 308. As can be seen, top 310 fails to point towards separate apparatus 304 and separate apparatus 306. As such, apparatus 302 may be precluded from interacting with separate apparatus 304 and/or separate apparatus 306 based, at least in part, on apparatus 302 pointing at rendering apparatus 308, apparatus 302 failing to point at separate apparatus 304, apparatus 302 failing to point at separate apparatus 306, and/or the like. In this manner, as depicted in the example of FIG. 3A, apparatus 302 may determine that apparatus 302 is pointing at separate apparatus 304. In such an example, apparatus 302 may receive information indicative of one or more media item candidate from separate apparatus 304 and may determine a rendering media item based, at least in part, on the media item candidate received from separate apparatus 304. Subsequently, apparatus 302 may be reoriented such that apparatus 302 is pointing at rendering apparatus 308, as depicted in the example of FIG. 3C. In this manner, apparatus 302 may cause rendering apparatus 308 to render the rendering media item associated with the media item candidate received from separate apparatus 304.

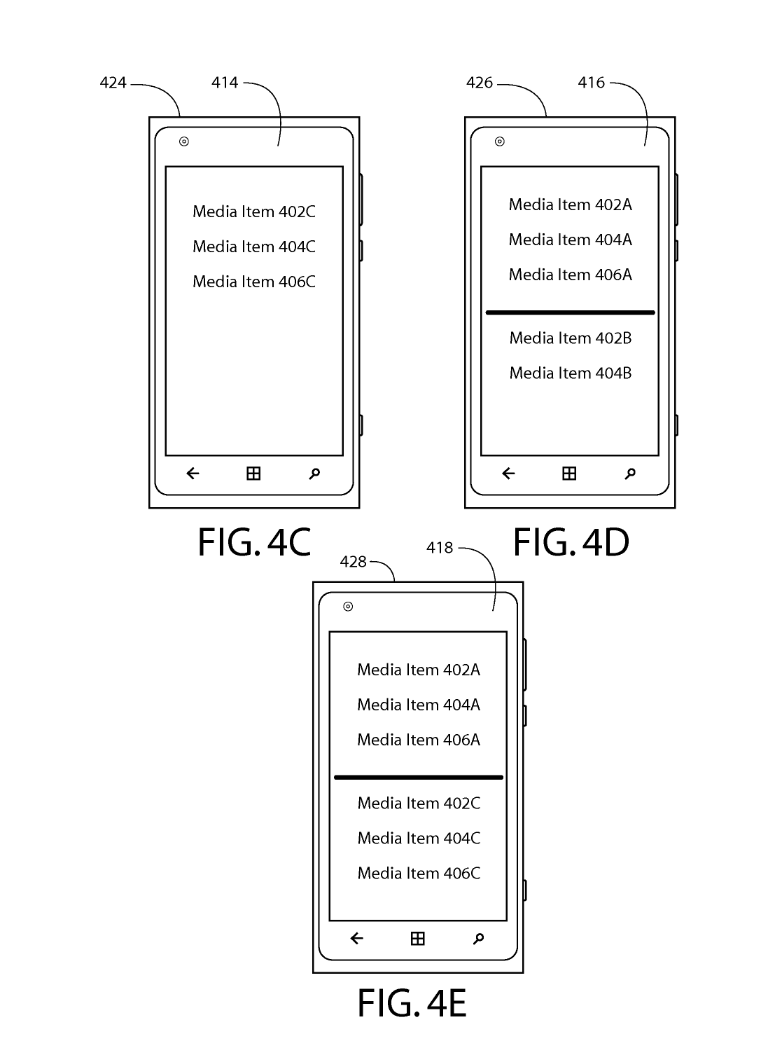

FIGS. 4A-4E are diagrams illustrating media item candidate interface elements according to at least one example embodiment. The examples of FIGS. 4A-4E are merely examples and do not limit the scope of the claims. For example, apparatus configuration may vary, media item candidate interface element count may vary, display content may vary, media item candidate interface element configuration may vary, and/or the like.

As discussed previously, in many circumstances, a user of an electronic apparatus may desire to cause rendering of a specific media item, to designate a particular media item candidate as a rendering media item, and/or the like. As such, it may be desirable to configure an electronic apparatus such that the user of the electronic apparatus may quickly and easily interact with the electronic apparatus, cause rendering of a specific media item, to designate a particular media item candidate as a rendering media item, and/or the like. In at least one example embodiment, an apparatus causes display of a media item candidate interface element that represents a media item candidate. In such an example embodiment, the causation of display of the media item candidate interface element may be based, at least in part, on the determination that the apparatus is pointing at the separate apparatus. In at least one example embodiment, an apparatus receives information indicative of a selection input. The selection input may be an input that identifies a particular media item candidate and the rendering media item. As such, the determination of the rendering media item may be based, at least in part, on a selection input that identifies the media item candidate as the rendering media item. In at least one example embodiment, the selection input is associated with a media item candidate interface element. For example, the apparatus may cause display of the media item candidate interface element at a display position on a display, and the selection input is at an input position on the display that corresponds with the display position. The selection input may be received subsequent to the determination that the apparatus is pointing at the rendering apparatus, prior to the determination that the apparatus is pointing at the rendering apparatus, subsequent to the determination that the apparatus is pointing at the separate apparatus, and/or the like.

In some circumstances, an electronic apparatus may be associated with one or more media items, may comprise at least one memory that comprises information indicative of one or more media items, may be subscribed to a service that provides streaming access to media items, and/or the like. In at least one example embodiment, a media item that is associated with the apparatus is a host media item. In one or more example embodiment, the apparatus determines at least one host media item candidate. The host media item candidate may be a media item that is associated with the apparatus. In such an example embodiment, a user of the apparatus may desire to cause a rendering apparatus to render a media item candidate, a host media item candidate, and/or the like. As such, the determination of the rendering media item may be based, at least in part, on media item candidate, a host media item candidate, and/or the like. In such an example, the apparatus may cause rendering of the host media item candidate, may determine a rendering media item based, at least in part, on the host media item and, subsequently, cause a rendering apparatus to render the rendering media item, and/or the like.

As discussed previously, it may be desirable to configure an electronic apparatus such that the user of the electronic apparatus may quickly and easily interact with the electronic apparatus, cause rendering of a specific media item, designate a particular media item candidate as a rendering media item, and/or the like. As such, in at least one example embodiment, an apparatus causes display of a media item candidate interface element that represents the host media item candidate. Display of the media item candidate interface element that represents the host media item candidate may be based, at least in part, on the determination that the apparatus is pointing at the separate apparatus, at the rendering apparatus, and/or the like. In such an example, the determination of the rendering media item may be based, at least in part, on a selection input that identifies the host media item candidate as the rendering media item. For example, the apparatus may receive information indicative of a selection input associated with the media item candidate interface element that represents the host media item candidate. In such an example, the apparatus may cause display of the media item candidate interface element at a display position on a display, and the selection input may be at an input position on the display that corresponds with the display position.

FIG. 4A is a diagram illustrating media item candidate interface elements according to at least one example embodiment. The example of FIG. 4A depicts apparatus 410 displaying media items 402A, 404A, and 406A. Each of media items 402A, 404A, and 406A is a media item candidate interface element that represents a particular host media item candidate. As such, media items 402A, 404A, and 406A are associated with apparatus 410. Apparatus 410 of FIG. 4A may correspond with apparatus 302 of FIGS. 3A-3C. As such, top 420 of apparatus 410 may be pointing at a separate apparatus, a different separate apparatus, a rendering apparatus, and/or the like. In the example of FIG. 4A, a user of apparatus 410 may desire to cause a rendering apparatus to render one or more of media items 402A, 404A, or 406A. In this manner, causation of a rendering apparatus to render of one or more of media items 402A, 404A, or 406A may comprise causation of the rendering apparatus to render the media item candidate that is represented by media items 402A, 404A, or 406A, respectively. As such, the user may orient apparatus 410 as depicted in the example of FIG. 3C. In this manner, top 420 of apparatus 410 may be pointing at rendering apparatus 308 of FIG. 3C. In such an example, the user may indicate that one of the host media item candidates represented by media items 402A, 404A, or 406A is a rendering media item by way of a selection input at an input position on the display of apparatus 410 that corresponds with a display position of media item 402A, 404A, or 406A on the display. In such an example, apparatus 410 may cause a rendering apparatus to render the rendering media item, the indicated host media item candidate, and/or the like.

FIG. 4B is a diagram illustrating media item candidate interface elements according to at least one example embodiment. The example of FIG. 4B depicts apparatus 412 displaying media items 402B and 404B. Each of media items 402B and 404B is a media item candidate interface element that represents a particular media item candidate. For example, apparatus 412 of FIG. 4B may correspond with apparatus 302 of FIGS. 3A-3C. As such, top 422 of apparatus 412 may be pointing at a separate apparatus, a different separate apparatus, a rendering apparatus, and/or the like. In the example of FIG. 4B, a user of apparatus 412 may desire to cause a rendering apparatus to render one or more of media items 402B or 404B. In this manner, causation of a rendering apparatus to render of one or more of media items 402B or 404B may comprise causation of the rendering apparatus to render the media item candidate that is represented by media items 402B or 404B, respectively.

In the example of FIG. 4B, the user of apparatus 412 may orient apparatus 412 as depicted in the example of FIG. 3A. In this manner, top 422 of apparatus 412 may be pointing at separate apparatus 304 of FIG. 3A. In such an example, media items 402B or 404B may be associated with separate apparatus 304 of FIG. 3A, comprised by separate apparatus 304 of FIG. 3A, and/or the like. In the example of FIG. 4B, apparatus 412 may be caused to display media items 402B and 404B based, at least in part, on a determination that top 422 of apparatus 412 is pointing towards separate apparatus 304 of FIG. 3A. In such an example, the user may indicate that one of the media item candidates represented by media items 402B or 404B is a rendering media item by way of a selection input at an input position on the display of apparatus 412 that corresponds with a display position of media item 402B or 404B on the display. In such an example, apparatus 412 may cause a rendering apparatus to render the rendering media item, the indicated media item candidate, and/or the like. For example, the user of apparatus 412 may orient apparatus 412 such that top 422 of apparatus 412 is oriented as depicted in the example of FIG. 3A and, subsequently, reorient apparatus 412 such that top 422 of apparatus 412 is oriented as depicted in the example of FIG. 3C. In this manner, the user may point apparatus 412 at separate apparatus 304, as depicted in FIG. 3A, and, subsequently, point apparatus 412 at rendering apparatus 308, as depicted in FIG. 3C. In such an example, apparatus 412 may receive information indicative of a selection input prior to the determination that apparatus 412 is pointing at the rendering apparatus, subsequent to the determination that apparatus 412 is pointing at the rendering apparatus, and/or the like.

FIG. 4C is a diagram illustrating media item candidate interface elements according to at least one example embodiment. The example of FIG. 4C depicts apparatus 414 displaying media items 402C, 404C, and 406C. Each of media items 402C, 404C, and 406C is a media item candidate interface element that represents a particular media item candidate. For example, apparatus 414 of FIG. 4C may correspond with apparatus 302 of FIGS. 3A-3C. As such, top 424 of apparatus 414 may be pointing at a separate apparatus, a different separate apparatus, a rendering apparatus, and/or the like. In the example of FIG. 4C, a user of apparatus 414 may desire to cause a rendering apparatus to render one or more of media items 402C, 404C, or 406C. In this manner, causation of a rendering apparatus to render of one or more of media items 402C, 404C, or 406C may comprise causation of the rendering apparatus to render the media item candidate that is represented by media items 402C, 404C, or 406C, respectively.

In the example of FIG. 4C, the user of apparatus 414 may orient apparatus 414 as depicted in the example of FIG. 3B. In this manner, top 424 of apparatus 414 may be pointing at separate apparatus 306 of FIG. 3B. In such an example, media items 402C, 404C, and 406C may be associated with separate apparatus 306 of FIG. 3B, comprised by separate apparatus 306 of FIG. 3B, and/or the like. In the example of FIG. 4C, apparatus 414 may be caused to display media items 402C, 404C, and 406C based, at least in part, on a determination that top 424 of apparatus 414 is pointing towards separate apparatus 306 of FIG. 3B. In such an example, the user may indicate that one of the media item candidates represented by media items 402C, 404C, or 406C is a rendering media item by way of a selection input at an input position on the display of apparatus 414 that corresponds with a display position of media item 402C, 404C, or 406C on the display. In such an example, apparatus 414 may cause a rendering apparatus to render the rendering media item, the indicated media item candidate, and/or the like. For example, the user of apparatus 414 may orient apparatus 414 such that top 424 of apparatus 414 is oriented as depicted in the example of FIG. 3B and, subsequently, reorient apparatus 414 such that top 424 of apparatus 414 is oriented as depicted in the example of FIG. 3C. In this manner, the user may point apparatus 414 at separate apparatus 306, as depicted in FIG. 3B, and, subsequently, point apparatus 414 at rendering apparatus 308, as depicted in FIG. 3C. In such an example, apparatus 414 may receive information indicative of a selection input prior to the determination that apparatus 414 is pointing at the rendering apparatus, subsequent to the determination that apparatus 414 is pointing at the rendering apparatus, and/or the like.

In many circumstances, a user of an electronic apparatus may be familiar with dragging gestures, drag inputs, and/or the like, in the context of moving an interface element, reallocating an interface element, and/or the like. In this manner, it may be desirable to configure an electronic apparatus such that a user of the electronic apparatus may initiate a selection input while pointing her electronic apparatus at a separate apparatus, reorient the electronic apparatus such that the electronic apparatus is pointing at a rendering apparatus while maintaining the selection input, and terminate the selection input while point her apparatus at the rendering apparatus. In this manner, the user seemingly drags the song from the separate apparatus to the rendering apparatus. In at least one example embodiment, a selection input comprises an initiation portion of the selection input and a termination portion of the selection input. For example, the initiation portion of the selection input may be a contact input, and the termination portion of the selection input may be a release input. In another example, the initiation portion of the selection input may be a button press input, and the termination portion of the selection input may be a button release input.

In such an example embodiment, the apparatus receives the initiation portion of the selection input subsequent to the determination that the apparatus is pointing at the separate apparatus and prior to the determination that the apparatus is pointing at the rendering apparatus. In this manner, the apparatus may receive the initiation portion of the selection input while the apparatus is being pointed at the separate apparatus, during reorientation of the apparatus, and/or the like. In such an example embodiment, the apparatus may receive the termination portion of the selection input prior to the determination that the apparatus is pointing at the rendering apparatus, subsequent to the determination that the apparatus is pointing at the rendering apparatus, and/or the like. In such an example embodiment, the apparatus may cause the rendering apparatus to render the rendering media item based, at least in part, on the initiation portion of the selection input, the termination portion of the selection input, the determination that the apparatus is pointing at the rendering apparatus, and/or the like. For example, a user may orient the user's apparatus as depicted in the example of FIG. 3A. In such an example, the user may select a media item candidate associated with separate apparatus 304 of FIG. 3A by way of a selection input. In such an example, the user may initiate the selection input while apparatus 302 is pointing at apparatus 304, and hold the selection input while reorienting the apparatus to the orientation depicted in the example of FIG. 3C. In such an example, the user may terminate the selection input while the apparatus is pointing at rendering apparatus 308 of FIG. 3C, prior to the determination that the apparatus is pointing at rendering apparatus 308 of FIG. 3C, and/or the like. In this manner, the user may cause rendering of the selected media item candidate associated with separate apparatus 304 of FIG. 3A by way of seemingly dragging the media item candidate from the separate apparatus to the rendering apparatus.

In some circumstances, a user may desire to render a plurality of media items in succession. For example, the user may desire to compile a list of media items to cause a rendering apparatus to render. In such an example, it may be desirable to configure an electronic apparatus such that a user of the electronic apparatus may add another media item to the list of media items such that the media item is eventually caused to be rendered. In at least one example embodiment, an apparatus causes display of at least another media item candidate interface element that represents at least another media item candidate in relation to the media item candidate interface element. In such an example embodiment, the other media item candidate may be associated with a media item playlist. A media item playlist may be a list of media items for rendering by a rendering apparatus, an indication of rendering media items for sequential rendering by a rendering apparatus, and/or the like.

In some circumstances, it may be desirable to cause display of media item candidate interface elements that represent media item candidates associated with a media item playlist. For example, it may be desirable to cause display of the media item candidate interface elements in relation to media item candidate interface elements that represent media item candidates associated with a separate apparatus, host media item candidate interface elements associated with the apparatus, and/or the like.

FIG. 4D is a diagram illustrating media item candidate interface elements according to at least one example embodiment. The example of FIG. 4D depicts apparatus 416 displaying media items 402A, 404A, and 406A. Each of media items 402A, 404A, and 406A is a media item candidate interface element that represents a particular media item candidate, a host media item candidate, a media item candidate associated with a media item playlist, and/or the like. The example of FIG. 4D also depicts apparatus 416 displaying media items 402B and 404B. Apparatus 416 of FIG. 4D may correspond with apparatus 302 of FIGS. 3A-3C. As such, top 426 of apparatus 416 may be pointing at a separate apparatus, a different separate apparatus, a rendering apparatus, and/or the like. For example, apparatus 416 may correspond with apparatus 302 of FIG. 3A, and media items 402B and 404B may be associated with separate apparatus 304 of FIG. 3A. In the example of FIG. 4D, a user of apparatus 416 may desire to cause a rendering apparatus to render one or more of media items 402B or 404B.

In such circumstances, it may be desirable to allow a user to indicate a desire to associate a media item candidate with a media item playlist in a manner that is easy and intuitive. In at least one example embodiment, an apparatus receives information indicative of a selection input that indicates a desire to associate a media item candidate with a media item playlist. In such an example embodiment, the selection input may comprise an initiation portion of the selection input and a termination portion of the selection input. The initiation portion of the selection input may be at a position that corresponds with the media item candidate interface element, and the termination portion of the selection input may be at a position that corresponds with the media item candidate interface element that is associated with the media item playlist. In the example of FIG. 4D, a user of apparatus 416 may desire to add the media item represented by media item 402B to the media item playlist that comprises indications of media items 402A, 404A, and 406A. In such an example, the user may initiate a selection input at an input position that corresponds with the display position of media item 402B on the display of apparatus 416, drag media item 402B into the upper portion of the display that is associated with display of the media item candidate interface elements associated with the media item playlist, and terminate the selection input at an input position that corresponds with the display position of any of media items 402A, 404A, or 406A.

In at least one example embodiment, the apparatus causes establishment of an association between the media item candidate and the media item playlist based, at least in part, on the termination portion of the selection input. For example, the apparatus may cause establishment of the association between the media item candidate and the media item playlist based, at least in part, on the termination portion of the selection input being at a position that corresponds with the other media item candidate interface element. In such an example embodiment, the determination of the rendering media item may be based, at least in part, on the association between the media item candidate and the media item playlist. As such, the causation of the rendering apparatus to render the rendering media item may be based, at least in part, on the association between the media item candidate and the media item playlist. For example, the causation of the rendering apparatus to render the rendering media item may comprise causation of the rendering apparatus to render the media item playlist. In such an example, the rendering of the media item playlist may comprise rendering of the rendering media item.

FIG. 4E is a diagram illustrating media item candidate interface elements according to at least one example embodiment. The example of FIG. 4E depicts apparatus 418 displaying media items 402A, 404A, and 406A. Each of media items 402A, 404A, and 406A is a media item candidate interface element that represents a particular media item candidate, a host media item candidate, a media item candidate associated with a media item playlist, and/or the like. The example of FIG. 4E also depicts apparatus 418 displaying media items 402C, 404C, and 406C. Apparatus 418 of FIG. 4E may correspond with apparatus 302 of FIGS. 3A-3C. As such, top 428 of apparatus 418 may be pointing at a separate apparatus, a different separate apparatus, a rendering apparatus, and/or the like. For example, apparatus 418 may correspond with apparatus 302 of FIG. 3B, and media items 402C, 404C, and 406C may be associated with separate apparatus 306 of FIG. 3B. In the example of FIG. 4E, a user of apparatus 418 may desire to cause a rendering apparatus to render one or more of media items 402C, 404C, or 406C. For example, a user of apparatus 418 may desire to add the media item represented by media item 404C to the media item playlist that comprises indications of media items 402A, 404A, and 406A. In such an example, the user may initiate a selection input at an input position that corresponds with the display position of media item 404C on the display of apparatus 418, drag media item 404C into the upper portion of the display that is associated with display of the media item candidate interface elements associated with the media item playlist, and terminate the selection input at an input position that corresponds with the display position of any of media items 402A, 404A, or 406A.

In some circumstances, a user may desire to selectively filter rendering of a media item candidate, to selectively allow rendering of a media item, to selectively preclude rendering of a media item candidate, and/or the like. For example, a user may enjoy listening to classical music, but may deplore listening to rock music. In such an example, the user may configure the user's electronic apparatus to cause filtering of media item candidates based, at least in part, on the user's preferences. In at least one example embodiment, an apparatus determines at least one media item selection criteria. The media item selection criteria may, for example, be a designation of a constraint on selection of a media item candidate based, at least in part, on metadata associated with the media item candidate. Metadata associated with an audio media item candidate may, for example, be a genre, a duration, a tempo, an artist, a composer, a production year, a lyrical content, a band origin, a style, a mood, a key, an artist gender, a presence of certain musical instruments, and/or the like. Metadata associated with an image media item candidate may, for example, be shading data, histogram data, subject matter data, location and orientation data, chronological data, a photographer, and/or the like. Metadata associated with a video media item candidate may, for example, be a duration, a genre, a producer, an actor, location and orientation data, chronological data, and/or the like. In at least one example embodiment, determination of the rendering media item may be based, at least in part, on the media item selection criteria.

In some circumstances, a user may desire to filter media item candidates at one or more separate apparatuses. For example, an apparatus may cause communication of at least one filtering criteria to the one or more separate apparatuses such that the separate apparatuses are caused to allow selection of a media item candidates satisfying the filtering criteria. In at least one example embodiment, an apparatus sends information indicative of a media item selection criteria to a separate apparatus. In such an example embodiment, a media item candidate received from the separate apparatus satisfies the media item selection criteria. The sending of information indicative of the media item selection criteria to the separate apparatus may cause the separate apparatus to constrain the media item candidate to a media item candidate that satisfies the media item selection criteria. In some circumstances, it may be desirable to filter media item candidates subsequent to receipt of the media item candidates from the separate apparatus. As such, in at least one example embodiment, the determination of the rendering media item is based, at least in part, on the media item selection criteria. In at least one example embodiment, prioritization of, arrangement of, etc. received media item candidates may be based, at least in part, on media item selection criteria. For example, if a user particularly enjoys rock music, a media item candidate characterized by a rock genre may be displayed more prominently than another media item candidate that failed to be characterized by the rock genre, may be caused to be rendered prior to the other media item candidate based, at least in part, on the media item candidate being characterized by the rock genre, and/or the like.

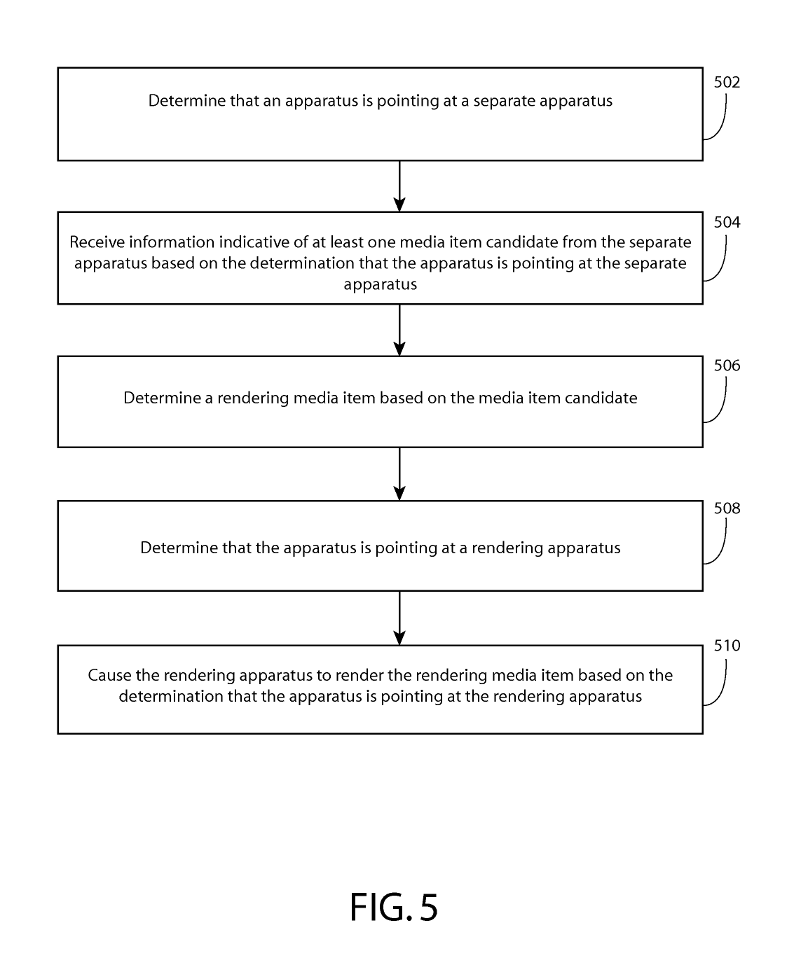

FIG. 5 is a flow diagram illustrating activities associated with causation of a rendering apparatus to render a rendering media item according to at least one example embodiment. In at least one example embodiment, there is a set of operations that corresponds with the activities of FIG. 5. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 5.

At block 502, the apparatus determines that an apparatus is pointing at a separate apparatus. The determination, the apparatus, and the separate apparatus may be similar as described regarding FIGS. 2A-2B and FIGS. 3A-3C.

At block 504, the apparatus receives information indicative of at least one media item candidate from the separate apparatus based, at least in part, on the determination that the apparatus is pointing at the separate apparatus. The receipt and the media item candidate may be similar as described regarding FIGS. 2A-2B, FIGS. 3A-3C, and FIGS. 4A-4E.

At block 506, the apparatus determines a rendering media item based, at least in part, on the media item candidate. The determination and the rendering media item may be similar as described regarding FIGS. 3A-3C and FIGS. 4A-4E.

At block 508, the apparatus determines that the apparatus is pointing at a rendering apparatus. The determination and the rendering apparatus may be similar as described regarding FIGS. 2A-2B and FIGS. 3A-3C.

At block 510, the apparatus causes the rendering apparatus to render the rendering media item based, at least in part, on the determination that the apparatus is pointing at the rendering apparatus. The causation and the rendering may be similar as described regarding FIGS. 2A-2B, FIGS. 3A-3C, and FIGS. 4A-4E.

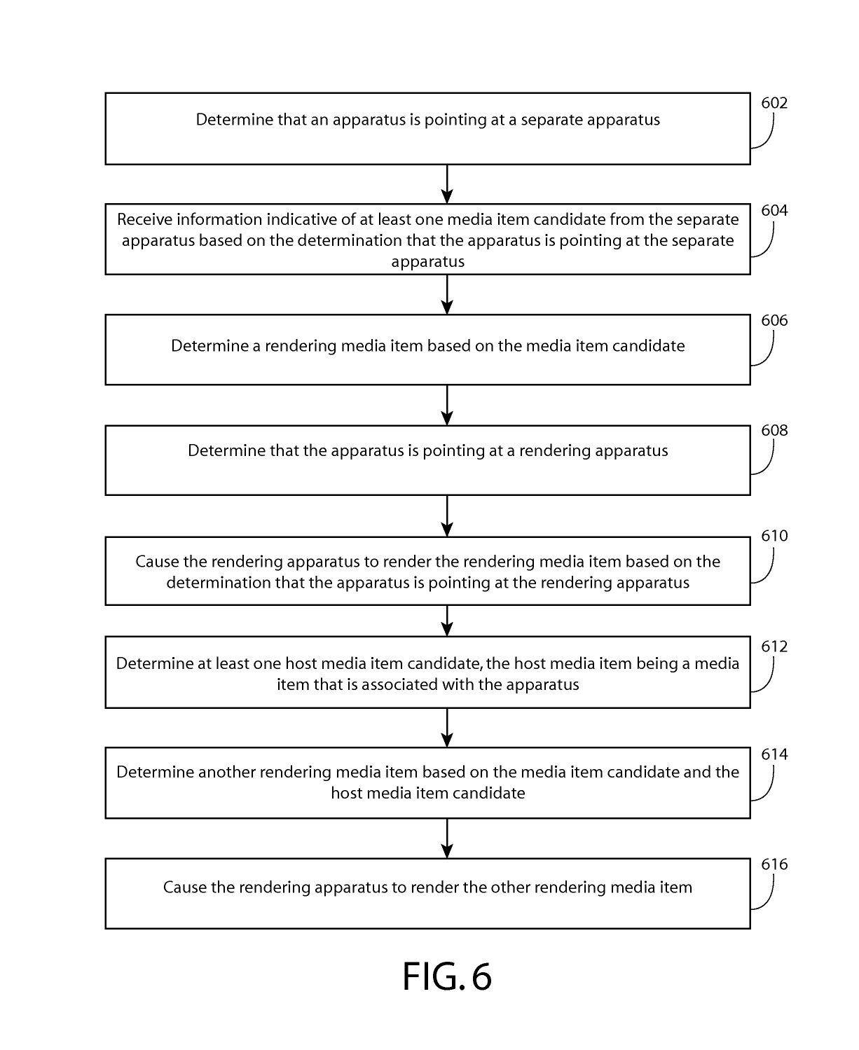

FIG. 6 is a flow diagram illustrating activities associated with causation of a rendering apparatus to render a rendering media item according to at least one example embodiment. In at least one example embodiment, there is a set of operations that corresponds with the activities of FIG. 6. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 6.

As discussed previously, in many circumstances, it may be desirable to configure an apparatus such that the apparatus may cause rendering of media items associated with the apparatus in addition to media items associated with one or more separate apparatuses. For example, a user of the apparatus may desire to cause a rendering apparatus to render a media item that is stored on the apparatus, streamed by the apparatus, and/or the like.

At block 602, the apparatus determines that an apparatus is pointing at a separate apparatus. The determination, the apparatus, and the separate apparatus may be similar as described regarding FIGS. 2A-2B and FIGS. 3A-3C.

At block 604, the apparatus receives information indicative of at least one media item candidate from the separate apparatus based, at least in part, on the determination that the apparatus is pointing at the separate apparatus. The receipt and the media item candidate may be similar as described regarding FIGS. 2A-2B, FIGS. 3A-3C, and FIGS. 4A-4E.

At block 606, the apparatus determines a rendering media item based, at least in part, on the media item candidate. The determination and the rendering media item may be similar as described regarding FIGS. 3A-3C and FIGS. 4A-4E.

At block 608, the apparatus determines that the apparatus is pointing at a rendering apparatus. The determination and the rendering apparatus may be similar as described regarding FIGS. 2A-2B and FIGS. 3A-3C.

At block 610, the apparatus causes the rendering apparatus to render the rendering media item based, at least in part, on the determination that the apparatus is pointing at the rendering apparatus. The causation and the rendering may be similar as described regarding FIGS. 2A-2B, FIGS. 3A-3C, and FIGS. 4A-4E.

At block 612, the apparatus determines at least one host media item candidate, the host media item candidate being a media item that is associated with the apparatus. The determination and the host media item candidate may be similar as described regarding FIGS. 3A-3C and FIGS. 4A-4E.

At block 614, the apparatus determines another rendering media item based, at least in part, on the media item candidate and the host media item candidate. The determination and the other rendering media item may be similar as described regarding FIGS. 3A-3C and FIGS. 4A-4E.

At block 616, the apparatus causes the rendering apparatus to render the other rendering media item. The causation and the rendering may be similar as described regarding FIGS. 2A-2B, FIGS. 3A-3C, and FIGS. 4A-4E.

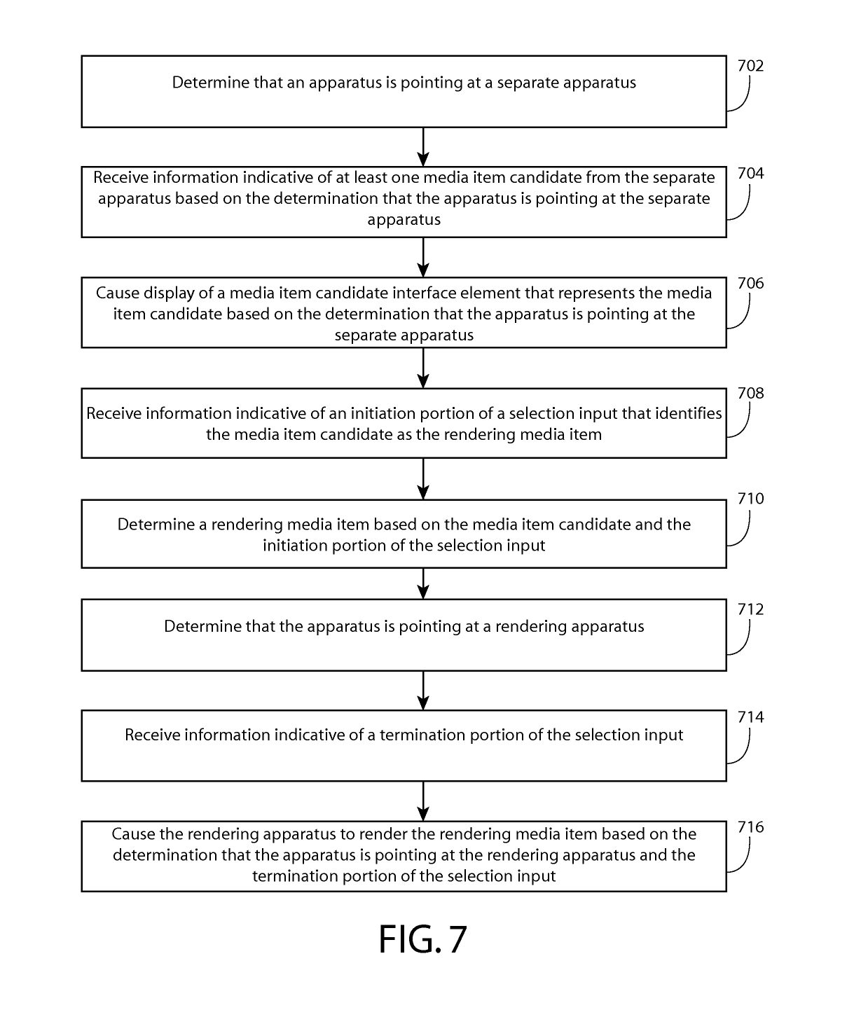

FIG. 7 is a flow diagram illustrating activities associated with causation of a rendering apparatus to render a rendering media item according to at least one example embodiment. In at least one example embodiment, there is a set of operations that corresponds with the activities of FIG. 7. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 7.

As discussed previously, in some circumstances, it may be desirable to configure an apparatus such that a user of the apparatus may interact with the apparatus in an easy and intuitive manner. As such, the user of the apparatus may be familiar with dragging gestures, drag inputs, and/or the like, in the context of moving an interface element, reallocating an interface element, and/or the like. In this manner, it may be desirable to configure an apparatus such that a user of the apparatus may initiate a selection input while pointing her apparatus at a separate apparatus, swing around to a rendering apparatus while maintaining the selection input, and terminate the selection input while point her apparatus at the rendering apparatus. In this manner, the user seemingly drags the song from the separate apparatus to the rendering apparatus.

At block 702, the apparatus determines that an apparatus is pointing at a separate apparatus. The determination, the apparatus, and the separate apparatus may be similar as described regarding FIGS. 2A-2B and FIGS. 3A-3C.

At block 704, the apparatus receives information indicative of at least one media item candidate from the separate apparatus based, at least in part, on the determination that the apparatus is pointing at the separate apparatus. The receipt and the media item candidate may be similar as described regarding FIGS. 2A-2B, FIGS. 3A-3C, and FIGS. 4A-4E.

At block 706, the apparatus causes display of a media item candidate interface element that represents the media item candidate based, at least in part, on the determination that the apparatus is pointing at the separate apparatus. The causation, the display, and the media item candidate interface element may be similar as described regarding FIGS. 2A-2B, FIGS. 3A-3C, and FIGS. 4A-4E.

At block 708, the apparatus receives information indicative of an initiation portion of a selection input that identifies the media item candidate as the rendering media item. The receipt, the selection input, and the initiation portion of the selection input may be similar as described regarding FIGS. 2A-2B, FIGS. 3A-3C, and FIGS. 4A-4E.

At block 710, the apparatus determines a rendering media item based, at least in part, on the media item candidate and the initiation portion of the selection input. The determination and the rendering media item may be similar as described regarding FIGS. 3A-3C and FIGS. 4A-4E.

At block 712, the apparatus determines that the apparatus is pointing at a rendering apparatus. The determination and the rendering apparatus may be similar as described regarding FIGS. 2A-2B and FIGS. 3A-3C.

At block 714, the apparatus receives information indicative of a termination portion of the selection input. The receipt and the termination portion of the selection input may be similar as described regarding FIGS. 2A-2B, FIGS. 3A-3C, and FIGS. 4A-4E.

At block 716, the apparatus causes the rendering apparatus to render the rendering media item based, at least in part, on the determination that the apparatus is pointing at the rendering apparatus and the termination portion of the selection input. The causation and the rendering may be similar as described regarding FIGS. 2A-2B, FIGS. 3A-3C, and FIGS. 4A-4E.

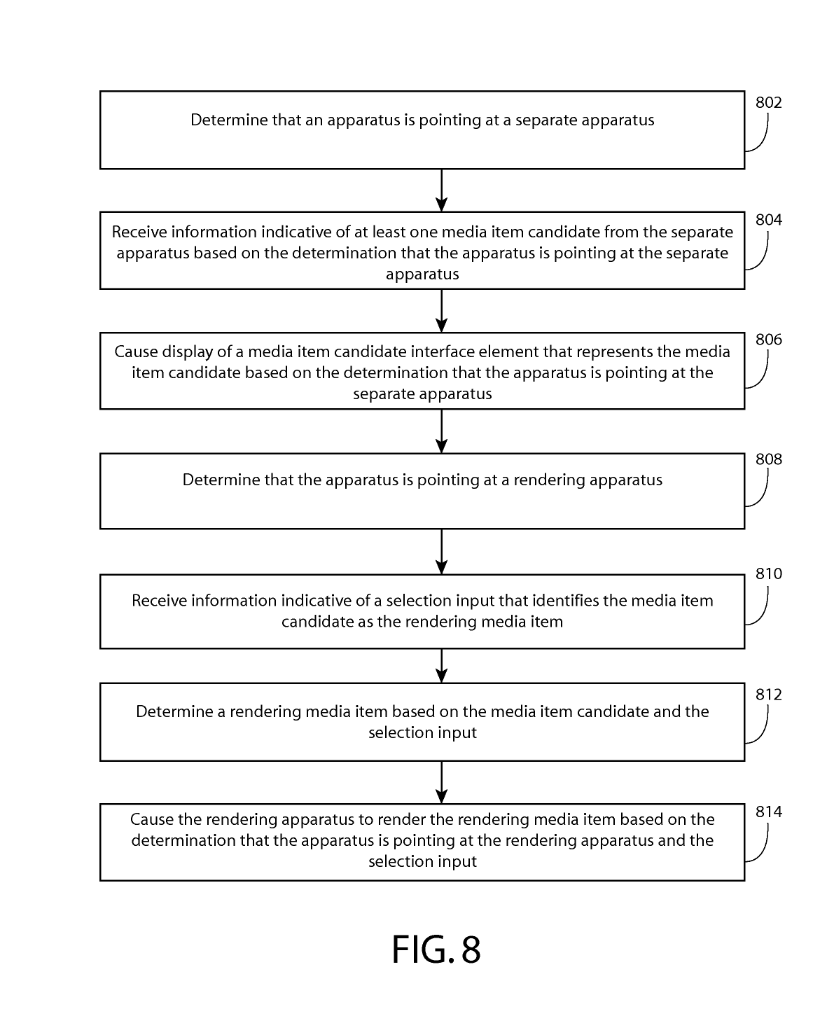

FIG. 8 is a flow diagram illustrating activities associated with causation of a rendering apparatus to render a rendering media item according to at least one example embodiment. In at least one example embodiment, there is a set of operations that corresponds with the activities of FIG. 8. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 8.

As discussed previously, in some circumstances, it may be desirable to configure an apparatus such that a user of the apparatus may cause a rendering apparatus to render a rendering media item. In such circumstances, the user may desire to render a specific media item, may desire to identify a specific media item candidate as the rendering media item, and/or the like. As such, it may be desirable to allow the user of the apparatus to identify that a specific media item candidate is the rendering media item by way of a selection input associated with a media item candidate interface element.

At block 802, the apparatus determines that an apparatus is pointing at a separate apparatus. The determination, the apparatus, and the separate apparatus may be similar as described regarding FIGS. 2A-2B and FIGS. 3A-3C.

At block 804, the apparatus receives information indicative of at least one media item candidate from the separate apparatus based, at least in part, on the determination that the apparatus is pointing at the separate apparatus. The receipt and the media item candidate may be similar as described regarding FIGS. 2A-2B, FIGS. 3A-3C, and FIGS. 4A-4E.

At block 806, the apparatus causes display of a media item candidate interface element that represents the media item candidate based, at least in part, on the determination that the apparatus is pointing at the separate apparatus. The causation, the display, and the media item candidate interface element may be similar as described regarding FIGS. 2A-2B, FIGS. 3A-3C, and FIGS. 4A-4E.

At block 808, the apparatus determines that the apparatus is pointing at a rendering apparatus. The determination and the rendering apparatus may be similar as described regarding FIGS. 2A-2B and FIGS. 3A-3C.

At block 810, the apparatus receives information indicative of a selection input that identifies the media item candidate as the rendering media item. The receipt and the selection input may be similar as described regarding FIGS. 2A-2B, FIGS. 3A-3C, and FIGS. 4A-4E.

At block 812, the apparatus determines a rendering media item based, at least in part, on the media item candidate and the selection input. The determination and the rendering media item may be similar as described regarding FIGS. 3A-3C and FIGS. 4A-4E.

At block 814, the apparatus causes the rendering apparatus to render the rendering media item based, at least in part, on the determination that the apparatus is pointing at the rendering apparatus and the selection input. The causation and the rendering may be similar as described regarding FIGS. 2A-2B, FIGS. 3A-3C, and FIGS. 4A-4E.

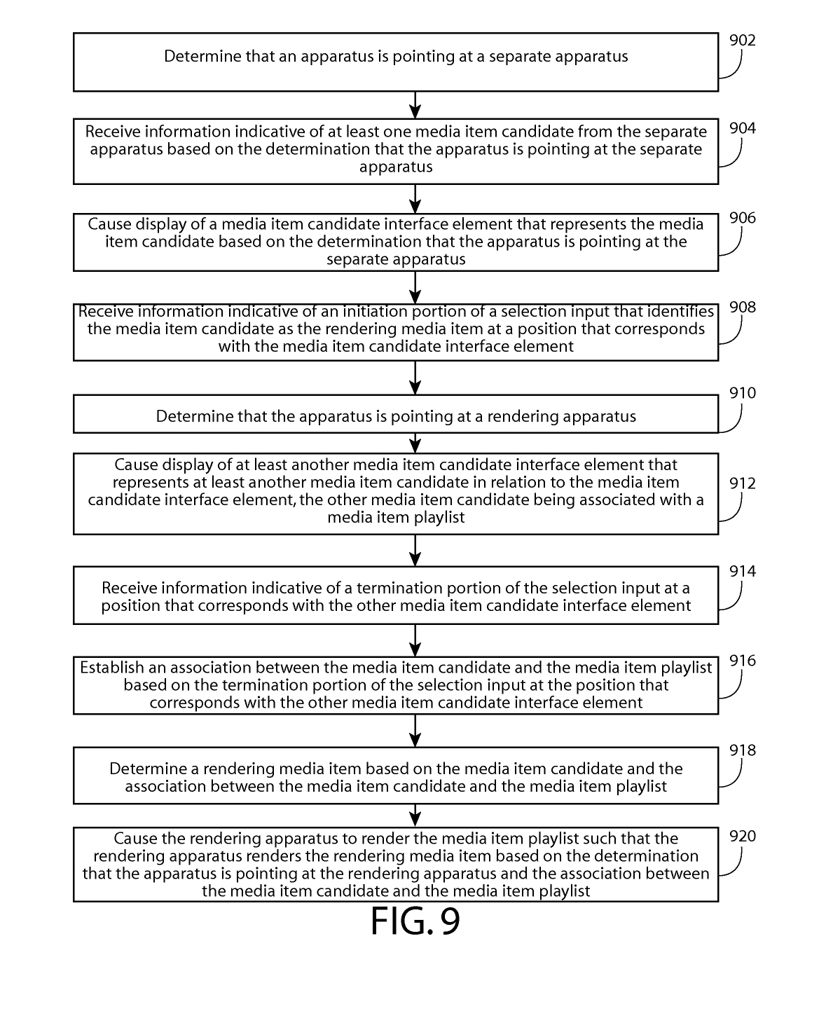

FIG. 9 is a flow diagram illustrating activities associated with causation of a rendering apparatus to render a media item playlist according to at least one example embodiment. In at least one example embodiment, there is a set of operations that corresponds with the activities of FIG. 9. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 9.

As discussed previously, in some circumstances, a user may desire to cause rendering of media items on a playlist. In such an example, the user may desire to add additional media items to the playlist such that the media items are eventually caused to be rendered. As such, it may be desirable to configure an apparatus such that a user of the apparatus may add one or more media item candidate to a media item playlist such that the media item candidate is subsequently caused to be rendered.

At block 902, the apparatus determines that an apparatus is pointing at a separate apparatus. The determination, the apparatus, and the separate apparatus may be similar as described regarding FIGS. 2A-2B and FIGS. 3A-3C.

At block 904, the apparatus receives information indicative of at least one media item candidate from the separate apparatus based, at least in part, on the determination that the apparatus is pointing at the separate apparatus. The receipt and the media item candidate may be similar as described regarding FIGS. 2A-2B, FIGS. 3A-3C, and FIGS. 4A-4E.

At block 906, the apparatus causes display of a media item candidate interface element that represents the media item candidate based, at least in part, on the determination that the apparatus is pointing at the separate apparatus. The causation, the display, and the media item candidate interface element may be similar as described regarding FIGS. 2A-2B, FIGS. 3A-3C, and FIGS. 4A-4E.

At block 908, the apparatus receives information indicative of an initiation portion of a selection input that identifies the media item candidate as the rendering media item. In such an example embodiment, the initiation portion of the selection input is at an input position that corresponds with a display position of the media item candidate interface element. The receipt, the selection input, the initiation portion of the selection input, the input position, the display position, and the correspondence of the input position and the display position may be similar as described regarding FIGS. 2A-2B, FIGS. 3A-3C, and FIGS. 4A-4E.

At block 910, the apparatus determines that the apparatus is pointing at a rendering apparatus. The determination and the rendering apparatus may be similar as described regarding FIGS. 2A-2B and FIGS. 3A-3C.

At block 912, the apparatus causes display of at least another media item candidate interface element that represents at least another media item candidate. In such an example embodiment, the other media item candidate interface element is displayed in relation to the media item candidate interface element, and the other media item candidate is associated with a media item playlist. The causation, the display, the other media item candidate interface element, the other media item candidate, and the media item playlist may be similar as described regarding FIGS. 2A-2B, FIGS. 3A-3C, and FIGS. 4A-4E.

At block 914, the apparatus receives information indicative of a termination portion of the selection input. In such an example embodiment, the termination portion of the selection input is at an input position that corresponds with a display position of the other media item candidate interface element. The receipt, the termination portion of the selection input, the input position, the display position, and the correspondence of the input position and the display position may be similar as described regarding FIGS. 2A-2B, FIGS. 3A-3C, and FIGS. 4A-4E.

At block 916, the apparatus establishes an association between the media item candidate and the media item playlist based, at least in part, on the termination portion of the selection input being at the position that corresponds with the other media item candidate interface element. The establishment and the association between the media item candidate and the media item playlist may be similar as described regarding FIGS. 2A-2B, FIGS. 3A-3C, and FIGS. 4A-4E.

At block 918, the apparatus determines a rendering media item based, at least in part, on the media item candidate and the media item playlist. The determination and the rendering media item may be similar as described regarding FIGS. 3A-3C and FIGS. 4A-4E.

At block 920, the apparatus causes the rendering apparatus to render the media item playlist such that the rendering apparatus renders the rendering media item based, at least in part, on the determination that the apparatus is pointing at the rendering apparatus and the association between the media item candidate and the media item playlist. The causation and the rendering may be similar as described regarding FIGS. 2A-2B, FIGS. 3A-3C, and FIGS. 4A-4E.

Embodiments of the invention may be implemented in software, hardware, application logic or a combination of software, hardware, and application logic. The software, application logic and/or hardware may reside on the apparatus, a separate device, or a plurality of separate devices. If desired, part of the software, application logic and/or hardware may reside on the apparatus, part of the software, application logic and/or hardware may reside on a separate device, and part of the software, application logic and/or hardware may reside on a plurality of separate devices. In an example embodiment, the application logic, software or an instruction set is maintained on any one of various conventional computer-readable media.

If desired, the different functions discussed herein may be performed in a different order and/or concurrently with each other. For example, block 710 of FIG. 7 may be performed after block 714 of FIG. 7. In another example, block 506 of FIG. 5 may be performed after block 508 of FIG. 5. Furthermore, if desired, one or more of the above-described functions may be optional or may be combined. For example, block 714 of FIG. 7 may be optional and/or combined with block 716 of FIG. 7.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are variations and modifications which may be made without departing from the scope of the present invention as defined in the appended claims.

What is claimed is:

1. An apparatus, comprising:
at least one processor;
at least one memory including computer program code, the memory and the computer program code configured to, working with the processor, cause the apparatus to perform at least the following:
determination that the apparatus is pointing at a separate apparatus;
receipt of information indicative of at least one media item candidate from the separate apparatus based, at least in part, on the determination that the apparatus is pointing at the separate apparatus;
determination of a rendering media item based, at least in part, on the media item candidate;
determination that the apparatus is pointing at a rendering apparatus; and
causation of the rendering apparatus to render the rendering media item based, at least in part, on the determination that the apparatus is pointing at the rendering apparatus.

2. The apparatus of claim 1, wherein the causation of the rendering apparatus to render the rendering media item comprises sending of the rendering media item to the rendering apparatus such that the rendering apparatus renders the rendering media item.

3. The apparatus of claim 1, wherein the memory includes computer program code configured to, working with the processor, cause the apparatus to perform causation of display of a media item candidate interface element that represents the media item candidate based, at least in part, on the determination that the apparatus is pointing at the separate apparatus.

4. The apparatus of claim 3, wherein the determination of the rendering media item is based, at least in part, on a selection input that identifies the media item candidate as the rendering media item.

5. The apparatus of claim 4, wherein the selection input comprises an initiation portion of the selection input and a termination portion of the selection input such that the apparatus receives the initiation portion of the selection input subsequent to the determination that the apparatus is pointing at the separate apparatus and prior to the determination that the apparatus is pointing at the rendering apparatus.

6. The apparatus of claim 5, wherein the apparatus receives the termination portion of the selection input subsequent to the determination that the apparatus is pointing at the rendering apparatus.

7. The apparatus of claim 4, wherein the memory includes computer program code configured to, working with the processor, cause the apparatus to perform causation of display of at least another media item candidate interface element that represents at least another media item candidate, the other media item candidate being associated with a media item playlist, and such that the other media item candidate interface element is displayed in relation to the media item candidate interface element.

8. The apparatus of claim 7, wherein the selection input comprises an initiation portion of the selection input and a termination portion of the selection input, the initiation portion of the selection input is at a position that corresponds with the media item candidate interface element, and the termination portion of the selection input is at a position that corresponds with the other media item candidate interface element.

9. The apparatus of claim 1, wherein the apparatus comprises a communication device, wherein the information indicative of the media item candidate is received from the separate apparatus by way of the communication device.

10. A method comprising:
determining that an apparatus is pointing at a separate apparatus;
receiving information indicative of at least one media item candidate from the separate apparatus based, at least in part, on the determination that the apparatus is pointing at the separate apparatus;
determining a rendering media item based, at least in part, on the media item candidate;
determining that the apparatus is pointing at a rendering apparatus; and
causing the rendering apparatus to render the rendering media item based, at least in part, on the determination that the apparatus is pointing at the rendering apparatus.

11. The method of claim 10, further comprising causing display of a media item candidate interface element that represents the media item candidate based, at least in part, on the determination that the apparatus is pointing at the separate apparatus.

12. The method of claim 11, wherein the determination of the rendering media item is based, at least in part, on a selection input that identifies the media item candidate as the rendering media item.

13. The method of claim 12, wherein the selection input comprises an initiation portion of the selection input and a termination portion of the selection input such that the apparatus receives the initiation portion of the selection input subsequent to the determination that the apparatus is pointing at the separate apparatus and prior to the determination that the apparatus is pointing at the rendering apparatus.

14. The method of claim 13, wherein the apparatus receives the termination portion of the selection input subsequent to the determination that the apparatus is pointing at the rendering apparatus.

15. The method of claim 12, further comprising causing display of at least another media item candidate interface element that represents at least another media item candidate, the other media item candidate being associated with a media item playlist, and such that the other media item candidate interface element is displayed in relation to the media item candidate interface element.

16. The method of claim 15, wherein the selection input comprises an initiation portion of the selection input and a termination portion of the selection input, the initiation portion of the selection input is at a position that corresponds with the media item candidate interface element, and the termination portion of the selection input is at a position that corresponds with the other media item candidate interface element.

17. At least one computer-readable medium encoded with instructions that, when executed by a processor, perform:
determination that an apparatus is pointing at a separate apparatus;
receipt of information indicative of at least one media item candidate from the separate apparatus based, at least in part, on the determination that the apparatus is pointing at the separate apparatus;
determination of a rendering media item based, at least in part, on the media item candidate;
determination that the apparatus is pointing at a rendering apparatus; and
causation of the rendering apparatus to render the rendering media item based, at least in part, on the determination that the apparatus is pointing at the rendering apparatus.

18. The medium of claim 17, further encoded with instructions that, when executed by a processor, perform causation of display of a media item candidate interface element that represents the media item candidate based, at least in part, on the determination that the apparatus is pointing at the separate apparatus.

19. The medium of claim 18, wherein the determination of the rendering media item is based, at least in part, on a selection input that identifies the media item candidate as the rendering media item.

20. The medium of claim 19, wherein the selection input comprises an initiation portion of the selection input and a termination portion of the selection input such that the apparatus receives the initiation portion of the selection input subsequent to the determination that the apparatus is pointing at the separate apparatus and prior to the determination that the apparatus is pointing at the rendering apparatus.
